(19) United States
(12) Patent Application Publication
(10) Pub. No.: US 2023/0174865 A1
(43) Pub. Date: Jun. 8, 2023

(54) FIREPROOF POLYMER ADDITIVE, METHOD OF ITS PRODUCTION AND APPLICATION

(71) Applicant: MOVYCHEM, S.R.O., Mocenok (SK)

(72) Inventors: Jiri VYLIMEC, Mocenok (SK); Roman MAGDINA, Prievidza (SK); Lubomir NEMECEK, Kurdejov (CZ)

(73) Assignee: MOVYCHEM, S.R.O., Mocenok (SK)

(21) Appl. No.: 17/998,031

(22) PCT Filed: May 4, 2021
(86) PCT No.: PCT/IB2021/053708

§ 371 Date: Nov. 5, 2022

(30) Foreign Application Priority Data
May 5, 2020 (SK) SK PP 50023-2020
May 5, 2020 (SK) SK PP 50024-2020

(51) Int. Cl. C09K 21/02

(52) U.S. Cl. CPC C09K 21/02

(57) ABSTRACT

Fireproof polymer additive is created from non-toxic components of a melt of waterless mixture of ammonium polyphosphate, pentaerythritol, and melamine and/or urea, with temperature ranging from 240° C. to 350° C.; the common melt is maintained at the said temperature for at least 30 seconds, subsequently it is left to cool and the solidified melt is disintegrated into particles smaller than 200 μm, preferably smaller than 50 μm, especially preferably smaller than 10 μm. Each of the two components can at the entry from 5 to 95% of the mass of the final mixture. In case of the realization with three or four components, each of the components can at the entry from 5 to 50% of the mass of the final mixture. The fireproof polymer additive is added to the basic material in ratio of 1% to 80% of the share of the mass of the resulting matter.

### CROSS REFERENCE TO RELATED APPLICATION

This application is a national stage entry of PCT/IB2021/053708 filed May 4, 2021, under the International Convention claiming priority over Slovakia Patent Application No. SK PP 50023-2020 filed May 5, 2020 and Slovakia Patent Application No. SK PP 50024-2020 filed May 5, 2020.

### FIELD OF TECHNOLOGY

The invention concerns a new polymer additive with high efficacy of suppression of smoke emission during the burning of the basic material. The basic material where the additive can be added is a whole range of plastics, resins, consolidators, or chemical reagents. The invention discloses a new method of production of fireproof polymer additive, which provides a substance for universal use, mainly in loose form or powder form, which can be easily mixed into the basic material.

### PRIOR STATE OF THE ART

In the past, a compound based on bromine (for example, pentabromodiphenyl ether) was generally applicable as a fireproof additive. Because such additives are highly toxic, their use diminishes. A use, for example, of boric acid (H₃BO₃, CAS No 10043-35-3) was widespread, even as far as 20% mass share. Boric acid is an inorganic acid that can be, pursuant to long-term studies, toxic, especially at high concentrations. Solutions are known which use other dangerous substances as retardants, such as CN102924868 (A), or they use substances which degrade the original physical-mechanical features of the original material.

A solution which uses ammonium polyphosphate and melamine in preparations for the increase of the fire resistance is known. The effects of such substances in independent fireproof applications have been sufficiently explored. Such substances are known, in the applications, as insoluble powders. For their use, as well as their use together with other substances in the basic materials, in this preferable to create a multiple addition without dangerous by-product. Pursuant to invention JPS58222146, a use of pentaerythritol and ammonium polyphosphate for the increase of resistance of polyurethane against fire is known.

Publications DE4234374, DE10047024 disclose a use of melamine, but in order to achieve sufficient fire resistance it is necessary to increase the share of melamine to the level which negatively affects other mechanical and chemical features of the resulting material.

A use of a urea as a fire retardant or as a component of the extinguishing substances is known, such as pursuant to publications U.S. 64/447,1861, WO8908137A1. Publication CA2169634A1 discloses a use of a urea as a fire retardant for plastics.

Published application WO/2017/179029 discloses a polymerization of the water solutions of pentaerythritol and ammonium polyphosphate, which partially solves the problems with preparation of the highly efficient fireproof additive. Publication WO/2016/207870 likewise discloses heating and mixing of the water solutions of pentaerythritol and ammonium polyphosphate and subsequent addition of the melamine. The resulting solution after polymerization is dried in order to get a dry granulate.

A new method of production of the fireproof additive is desired and not known, where a new, more effective fireproof and also smokeproof additive is obtained from the tried and tested components. A new fireproof additive shall contain not only substances without any dangerous effects pursuant to all known studies, but the new method shall be simple, universally applicable with various ratios of components.

### SUMMARY OF THE INVENTION

The abovementioned deficiencies in the prior state of the art are significantly remedied by the polymer additive in the loose form according to this invention which essence lies in the fact that it is formed by the milled mixed melt of ammonium polyphosphate and pentaerythritol. The mixing of ammonium polyphosphate and pentaerythritol on the water basis is known in the prior art, however, this leads to limitation of the temperature of the polymerization to the boiling temperature of the water. The significant feature of the proposed invention is the increase of the temperature of polymerization of the two entry components compared to the polymerization of water solutions, which is accompanied by a different result of the products of the polymerization, as far as the scope of individual components is concerned, too. In the preferable arrangement, a third component can be added into polymerization; this component being melamine and/or urea.

Melamine and/or urea are also in the waterless state melted into melt. In such case the fireproof polymer additive is in the loose state formed by a milled mixed melt of ammonium polyphosphate and pentaerythritol and melamine and/or urea. The term “melt” in this text denotes a melted substance, that is, melted solid or loose substance, respectively, or mixture of solid substances.

The loose form of the fireproof polymer additive is advantageous due to its universal use in various applications. A granulation below 200 μm, more preferably below 50 μm, especially preferably below 10 μm, proved preferable.

Each of two components at the entry can form from 5 to 90% of the mass of the resulting mixture. In case the mixture is produced out of three or four components, each of the three or four components can, at the entry, from 5 to 50% of the mass of the resulting mixture.

Deficiencies in the prior state of the art are significantly remedied by the method of production of the fireproof polymer additive in the loose form itself, too, whereby in this method a polymerization of the chains from the entry components takes place and the entry components are ammonium polyphosphate and pentaerythritol, according to this invention, which essence lies in the fact that the entry components are in the waterless form heated to the temperature ranging from 240° C. to 350° C. while the melt is produced; the common mixed melt is maintained at the temperature ranging from 240° C. to 350° C. for at least 30 seconds; subsequently it is left to cool and the solidified melt is disintegrated to particles smaller than 200 μm, preferably smaller than 50 μm, especially preferably smaller than 10 μm. In the preferably arrangement the method includes the polymerization in the melt with the added melamine and/or urea.

Ammonium polyphosphate [NH₄PO₃]ₙ is used as a food additive, emulsifier (E545). It is also used as a halogen-free fire retardant. Pursuant to the level of polymerization there are two main groups of ammonium polyphosphate: crystalline phase I APP and crystalline phase II APP. Phase I ammonium polyphosphate's chain is short and linear (n<100), more sensitive to water and less thermally stable; it begins to disintegrate at temperatures above 150° C. Phase II ammonium polyphosphate has high level of polymerization at n>1000, its structure is crosslinked (branched) and has higher thermal stability; its disintegration begins are approximately 285° C. to 300° C. and its solubility in water is also higher than in case of phase I APP.

Pentaerythritol, 2,2-Bis(hydroxymethyl)1,3-propanediol, C₆H₁₂O₄, CAS 115-77-5, is white crystalline powder, tetravalent monotopic alcohol. It is used for the production of alkyd resins, emulsifiers, explosives, paints, synthetic lubricating oils. It is considered an ecological substitute for polyvinylchlorobiphenyls (PCB).

Melamine, 2,4,6-triamino-1,3,5-triazine, summary formula C₃—H₆—N₆, CAS 108-78-1, is used mainly to produce plastics and nitrogenous fertilizers. Melamine is not toxic in small amounts. Pursuant to its undesired presence in the food, melamine is described as harmful, but the level of toxicity in the food is comparable to the kitchen salt, it surpasses 3 g per kilogram of the live weight of the individual. Seen this way, the use of melamine as an additive pursuant to this invention is harmless.

Urea (diaminomethane, carbonyl amide, carbonic acid diamide) is an organic compound of carbon, oxygen, nitrogen and hydrogen. The summary formula of the urea is CON₂H₄, constitutional formula is NH₂—CO—NH₂, CAS number is 57-13-6.

An important advantage of the proposed invention is the obtaining of the highly efficient fireproof and smokeproof additive with the use of harmless entry substances, whereby the polymerization in the environment of the waterless melt produces a new substance or new group of substances, respectively. After the milling of the cooled melt the fireproof polymer additive has a final form of a powder which can be preferably mixed into various basic materials. The fact that if the entry components have a boiling temperature more than 240° C.—in case of phase II ammonium polyphosphate it is more than 280° C. —, then the resulting melt and powder which results from the milling of said melt have boiling temperature at the level of 175° C., attests to the production of a new substance or the new group of substances, respectively.

In one arrangement, the method can at first include mixing of the unheated entry components in the dry, waterless state, where these components are mechanically mixed and the resulting mixture of the solid particles is boiled to the point of melt in which the polymerization takes place. In another arrangement each entry component can be heated independently while the melt is produced and subsequently the liquid forms of entry components are mixed into the common melt in which the polymerization takes place. A method is also possible where the brought entry components are placed into a common vessel where they are at the same time mixed and heated, which causes a mixing of the dry mixtures at first and then, gradually, the mixing of the melt of individual components into a common melt. The common melt has a temperature of 240° C. to 350° C. for at least 30 seconds so that the polymerization into a final product takes place.

The structural formula of the final product cannot be exactly determined, since the final product is probably formed by a large number of components, even pursuant to the chosen mutual ratio of the individual components, which can vary a lot.

Two entry components can have a following ratio to the resulting mass of the melt:

ammonium polyphosphate from 5% to 95% of the mass,

pentaerythritol from 5% to 95% of the mass,

for example, in particular:

| entry | | | |
|---|---|---|---|
| component | method no. 1 | method no. 2 | method no. 3 |
| ammonium | 50% of the mass | 25% of the mass | 75% of the mass |
| polyphosphate | | | |
| pentaerythritol | 50% of the mass | 75% of the mass | 25% of the mass |

In case of realization with three or four entry components, the entry components can have a following ratio to the resulting mass of the melt:

ammonium polyphosphate from 5% to 50% of the mass,

entaerythritol from 5% to 50% of the mass,

melamine and/or urea from 5% to 50% of the mass

for example, in particular:

| entry | | | |
|---|---|---|---|
| component | method no. 1 | method no. 2 | method no. 3 |
| ammonium | 50% of the mass | 34% of the mass | 25% of the mass |
| polyphosphate | | | |
| pentaerythritol | 25% of the mass | 33% of the mass | 25% of the mass |
| melamine | 25% of the mass | 33% of the mass | 50% of the mass |

or:

| entry | | | |
|---|---|---|---|
| component | method no. 1 | method no. 2 | method no. 3 |
| ammonium | 50% of the mass | 34% of the mass | 25% of the mass |
| polyphosphate | | | |
| pentaerythritol | 25% of the mass | 33% of the mass | 25% of the mass |
| urea | 25% of the mass | 33% of the mass | 50% of the mass |

or:

| entry | | | |
|---|---|---|---|
| component | method no. 1 | method no. 2 | method no. 3 |
| ammonium | 50% of the mass | 25% of the mass | 20% of the mass |
| polyphosphate | | | |
| pentaerythritol | 20% of the mass | 25% of the mass | 20% of the mass |
| melamine | 15% of the mass | 25% of the mass | 30% of the mass |
| urea | 15% of the mass | 25% of the mass | 30% of the mass |

Melamine can be melamine cyanurate or melamine borate or melamine polyphosphate or melamine diphosphate or melamine pyrophosphate or melamine phosphate.

Disintegration of the melt can take place after cooling below 150° C., preferably after cooling to the temperature of the environment. The disintegration can include milling, cutting, crushing, grinding or similar mechanical treatment, for example in a ball mill, whereby it will be preferable if the milled matter is separated in a sieve of various sizes in order to achieved the desired granulometry.

Fireproof polymer additive prevents the process of burning also in such a way that it releases, around the cores in the basic matter into which it is applied, CO₂ and nitrogenous gases. Nitrogen, led to the melt mainly by adding melamine, significantly diminishes the smokiness and flammability of the basic material. A combination of two or three or four entry components in the resulting polymer allows not only for achievement of a high fire resistance and decrease in smokiness, but the mechanical features of the basic material are maintained or improved, too. A significant decrease in the smokiness is achieved already with a small share of the fireproof polymer additive in the basic material.

Tests to identify elements and substances by EDS, FTIR, TD-GC-MS methods proved that there is at least partial polymerization in the melt; that precursors and derivates of the entry components are produced. Even though no structural formulas of the essential parts of the new substance have been determined, tests proved strong fire resistant and smoke resistant effect, clearly surpassing the summary effects of the entry components.

Fireproof polymer additive can be applied as a powder mixed into the granulate of the thermoplastic when it is injected into the mold, or it can be mixed into a thermoset plastic, or it can be mixed into some component of the epoxy resin or polyester resin or vinyl ester resin, or into polyurethane base or into elastomeric rubber or bioplastic, whereby the share of the fireproof polymer additive in the final product can range from 1% to 80% of the mass.

An application of the fireproof polymer additive into the basic material, which is during the production of the final product treated at the temperature higher than 175° C.—where the particles of the mixed fireproof polymer additive are melted—is especially preferable.

All entry components as well as the final product are registered in REACH as substances without any harmful effects on a man. That means that the method of polymerization and combination of safe substances, which lead to high fire resistance even at low costs and low energy consumption of the process, has been invented. The invention has high fireproof effects and it uses non-toxic substances.

### BRIEF DESCRIPTION OF DRAWINGS

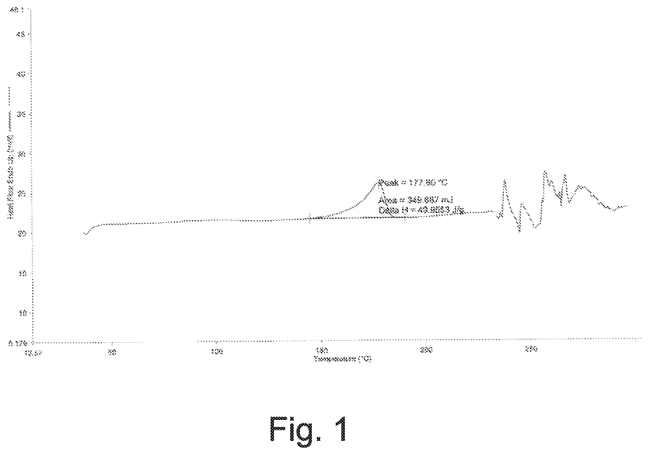

The invention is further disclosed by means of FIG. 1, which shows a thermogravimetric melting curve of the fireproof polymer additive with three entry components. The highest measured temperature of melting at 177.8° C. shows a creation of a new substance different from the entry components, whose melting temperature is above 240° C. The depicted particular peak of the curve is for illustration purposes only—it is related to the particular chosen ration of the entry components and cannot be interpreted as limiting the scope of protection.

### EXAMPLES OF REALIZATION

### Example 1

In this example two components of the melt are weighed and chosen followingly: ammonium polyphosphate in amount of 50 mass parts, pentaerythritol in amount of 50 mass parts. The entry components in loose, waterless form are placed into the common vessel where they are mixed and subsequently heated beyond 285° C., whereby a common melt is produced which is mixed and maintained at the temperature beyond 285° C. for at least two minutes. Subsequently the melt of the new created substance is left to cool. The melt of the new substance solidifies at the temperature below 175° C. In this example the cooling continues until the temperature of the environment is reached. Subsequently, the solidified matter of the melt is milled in ball mill and then it proceeds to the separating sieve with 50 μm, whereby the larger particles return to the ball mill.

Resulting fireproof polymer additive in the loose powder state is packed into bags and subsequently added to the granulate of thermoplastic before its injection into a mold where at least partial melting of the fireproof polymer additive takes place at temperatures beyond 175° C.

### Example 2

In this example three components of the melt are weighed and chosen followingly: ammonium polyphosphate in amount of 50 mass parts, pentaerythritol in amount of 30 mass parts and melamine in the amount of 20 mass parts. The entry components in loose, waterless form are placed into the common vessel where they are mixed and subsequently heated beyond 270° C., whereby a common melt is produced which is mixed and maintained at the temperature beyond 270° C. for at least three minutes. Subsequently the melt of the new created substance is left to cool. The melt of the new substance solidifies at the temperature below 175° C., pursuant to FIG. 1. In this example the cooling continues until the temperature of the environment is reached. Subsequently, the solidified matter of the melt is milled in ball mill and then it proceeds to the separating sieve with 100 μm.

Resulting fireproof polymer additive in the loose powder state is packed into bags and subsequently added to the granulate of thermoplastic before its injection into a mold where at least partial melting of the fireproof polymer additive takes place at temperatures beyond 175° C.

### Example 3

In this example three components of the melt are weighed and chosen followingly: ammonium polyphosphate in amount of 40 mass parts, pentaerythritol in amount of 40 mass parts and melamine in the amount of 20 mass parts.

Entry components are independently melted at temperatures beyond 250° C. and subsequently mixed into the common melt, where polymerization takes place for at least 5 minutes. The melt of the resulting substance is cooled and disintegrated into fraction below 10 μm.

### Example 4

In this example three components of the melt are weighed and chosen followingly: ammonium polyphosphate in amount of 40 mass parts, pentaerythritol in amount of 20 mass parts and urea in the amount of 30 mass parts.

Entry components are independently melted at temperatures beyond 240° C. and subsequently mixed into the common melt, where polymerization takes place for at least 5 minutes. The melt of the resulting substance is cooled and disintegrated into fraction below 50 μm.

### Example 5

In this example four components of the melt are weighed and chosen followingly: ammonium polyphosphate in amount of 30 mass parts, pentaerythritol in amount of 20 mass parts, melamine in the amount of 25 mass parts and urea in the amount of 25 mass parts.

Entry components are melted together at temperature beyond 260° C. while they are continuously mixed, whereby the polymerization takes place in the common melt for at least 4 minutes. The melt of the resulting substance is cooled and disintegrated into fraction below 200 μm.

### Example 6

Fireproof polymer additive in the loose state with the fraction below 5 μm is mixed into one of the two components of the epoxy resin with a share of 20% of the mass within an overall mass of the resulting epoxy resin. The epoxy resin is used in the electrotechnics industry, it has high fire resistance and even with a fire exposure it shows no smokiness.

### Example 7

In this example three components of the melt are weighed and chosen followingly: ammonium polyphosphate in amount of 34 mass parts, pentaerythritol in amount of 33 mass parts and melamine in the amount of 33 mass parts. The resulting melt of the new substance solidifies at the temperature below 175° C.

### INDUSTRIAL APPLICABILITY

Industrial applicability of the invention is obvious. According to this invention it is possible to industrially and repeatedly produce and use fireproof polymer additive with high efficacy, which has no toxic components.

1. A fireproof polymer additive in a loose form
at least partial polymerization of a waterless melt of ammonium polyphosphate and pentaerythritol.

2. The fireproof polymer additive according to the claim 1, wherein each of the components have at an entry a share of 5% to 95% of a mass of the resulting additive.

3. The fireproof polymer additive according to claim 1, further comprising melamine and/or a urea.

4. The fireproof polymer additive, according to claim 3, wherein the melamine and/or a urea has at the entry the share of 5 to 50% of the mass of the resulting additive.

5. The fireproof polymer additive according to claim 1, wherein the at least partial polymerization of a waterless melt of ammonium polyphosphate is ammonium polyphosphate of a second crystalline phase.

6. The fireproof polymer additive, according to claim 1, wherein the fireproof polymer has a granulation below 200 μm.

7. A method of a production of a fireproof polymer additive in a loose form, the method comprising the steps of:
producing a waterless polymerization from ammonium polyphosphate and pentaerythritol,
heating the waterless chain polymerization from ammonium polyphosphate and pentaerythritol to a temperature ranging from 240° C. to 350° C. to produce a melt,
maintaining the melt at a temperature ranging from 240° C. to 350° C. for at least 30 seconds;
cooling the melt to produce a solidified melt,
disintegrating the solidified melt into particles.

8. The method according to claim 7, wherein the ammonium polyphosphate is ammonium polyphosphate of a second crystalline phase and
wherein heating step is at a temperature ranging from 285° C. to 350° C.

9. The method according to claim 7, the melt contains: ammonium polyphosphate from 5% to 95% of the mass and pentaerythritol from 5% to 95% of the mass.

10. The method according to claim 7, wherein the melamine is dissolved from the loose waterless form at the heightened temperature is part of the melt.

11. The method according to claim 10, the melamine is melamine cyanurate, melamine borate, melamine polyphosphate, melamine diphosphate, melamine pyrophosphate, or melamine phosphate.

12. The method according to claim 7, further including the steps of dissolving urea from the loose or solid waterless form at the heightened temperature is part of the melt.

13. The method according to claim 10, wherein the melt contains: ammonium polyphosphate from 5% to 50% of the mass; pentaerythritol from 5% to 50% of the mass; melamine and/or the urea from 5% to 50% of the mass.

14. The method according to claim 7, wherein the solidified melt is disintegrated into particles smaller than 200 μm.

15. The method according to claim 7, wherein firstly, the unheated entry components in the dry waterless state are mechanically mixed and subsequently a mixture of a solid particles of the entry components is heated to the melt.

16. The method according to claim 7, wherein:
the ammonium polyphosphate and the pentaerythritol are independently heated until are melted and subsequently mixed into the melt. or
the ammonium polyphosphate and the pentaerythritol are simultaneously mixed and heated into the melt.

17. (canceled)

18. The method according to the claim 7, wherein the melt is disintegrated after cooling below 150° C.

19. A method of an application of the fireproof polymer additive produced according to claim 7, wherein the fireproof polymer additive is added to a basic material in a ratio of 1% to 80% of the mass of the final matter.

20. The method according to claim 19, wherein the fireproof polymer additive is added to the basic material with the melting temperature less than 175° C. and subsequently during a treatment of the plastic basic material it is at least partially melted.

21. The method according to the claim 19, wherein the fireproof polymer additive is:
mixed into a granulate of a thermoplastic before its injection into a mold; or
mixed into a thermoset plastic, into an epoxy resin, a polyester resin, a vinyl ester resin, a polyurethane base, an elastomeric rubber, or a bioplastic.

22. (canceled)
